(19) United States
(12) Patent Application Publication
(10) Pub. No.: US 2025/0245433 A1
(43) Pub. Date: Jul. 31, 2025

(54) DETECTING ARTIFICIAL INTELLIGENCE GENERATED TEXT IN LARGE DOCUMENT CORPORA

(71) Applicant: NEC Laboratories America, Inc., Princeton, NJ (US)

(72) Inventor: Zachary Izzo, Cranbury, NJ (US)

(21) Appl. No.: 19/039,107

(22) Filed: Jan. 28, 2025

Related U.S. Application Data
(60) Provisional application No. 63/627,695, filed on Jan. 31, 2024.

(51) Int. Cl. G06F 40/284

(52) U.S. Cl. CPC G06F 40/284

(57) ABSTRACT

Systems and methods for detecting artificial intelligence generated text in large document corpora. An AI-generated document corpus and a human-written document corpus can be generated using identified prompts. Text distributions of human-written text and AI-generated text from the corpus of AI generated documents and the corpus of human-written documents can be estimated using token statistics. A detection distribution of AI generated documents from a target corpus can be estimated with maximum likelihood estimation using the text distributions. Detection flags for the AI generated documents from the target corpus can be generated based on the detection distribution.

### RELATED APPLICATION INFORMATION

This application claims priority to U.S. Provisional App. No. 63/627,695, filed on Jan. 31, 2024, incorporated herein by reference in its entirety.

### BACKGROUND

### Technical Field

The present invention relates to detecting artificial intelligence (AI) generated text, and more particularly to detecting artificial intelligence generated text in large document corpora.

### Description of the Related Art

The remarkable progress in large pre-trained large language models (LLMs) has brought machine-generated text closer to human-written text in both fluency and diversity. Due to this progress, producing large number of documents for various fields such as education, news, or healthcare can be achieved in shorter time. However, this also poses a difficult question for distinguishing whether the documents has been machine-generated or human created.

### SUMMARY

According to an aspect of the present invention, a computer-implemented method is provided for detecting artificial intelligence (AI) generated text, including, generating a corpus of artificial intelligence (AI) generated documents with a large language model and a corpus of human-written documents using identified prompts, estimating text distributions of human-written text and AI-generated text from the corpus of AI generated documents and the corpus of human-written documents using token statistics, estimating a detection distribution of AI generated documents from a target corpus with maximum likelihood estimation using the text distributions, and generating detection flags for documents from the target corpus based on the detection distribution.

According to another aspect of the present invention, a system is provided for detecting artificial intelligence (AI) generated text, including, a memory device, one or more processor devices operatively coupled with the memory device causing the processor devices to perform, generating a corpus of artificial intelligence (AI) generated documents with a large language model and a corpus of human-written documents using identified prompts, estimating text distributions of human-written text and AI-generated text from the corpus of AI generated documents and the corpus of human-written documents using token statistics, estimating a detection distribution of AI generated documents from a target corpus with maximum likelihood estimation using the text distributions, and generating detection flags for documents from the target corpus based on the detection distribution.

According to yet another aspect of the present invention, a non-transitory computer program product including a computer-readable storage medium having program code for detecting artificial intelligence (AI) generated text, wherein the program code when executed on a computer causes the computer to perform, generating a corpus of artificial intelligence (AI) generated documents with a large language model and a corpus of human-written documents using identified prompts, estimating text distributions of human-written text and AI-generated text from the corpus of AI generated documents and the corpus of human-written documents using token statistics, estimating a detection distribution of AI generated documents from a target corpus with maximum likelihood estimation using the text distributions, and generating detection flags for documents from the target corpus based on the detection distribution.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram showing a high-level computer-implemented method for detecting artificial intelligence (AI) generated text in large document corpora, in accordance with one embodiment of the present invention;

FIG. 2 is a flow diagram showing verifying performance accuracy by comparing an estimated detection distribution with known distributions of AI-generated text and human-written text, in accordance with an embodiment of the present invention;

FIG. 3 is a block diagram showing a system implementing practical applications for detecting AI-generated text in large document corpora, in accordance to an embodiment of the present invention; and

FIG. 4 is a block diagram showing a system for detecting AI generated text in large document corpora, in accordance with an embodiment of the present invention;

FIG. 5 is a block diagram showing a system for detecting AI generated text in large document corpora, in accordance with an embodiment of the present invention; and

FIG. 6 is a block diagram showing a structure of deep neural networks for detecting AI generated text in large document corpora, in accordance with an embodiment of the present invention.

### DETAILED DESCRIPTION OF PREFERRED EMBODIMENTS

In accordance with embodiments of the present invention, systems and methods are provided for detecting artificial intelligence (AI) generated text for large document corpora.

In an embodiment, an AI-generated document corpus and a human-written document corpus can be generated using identified prompts. Text distributions of human-written text and AI-generated text from the corpus of AI generated documents and the corpus of human-written documents can be estimated using token statistics. A detection distribution of AI generated documents from a target corpus can be estimated with maximum likelihood estimation using the text distributions. Detection flags for the AI generated documents from the target corpus can be generated based on the detection distribution.

AI, specifically large language models (LLMs), have emerged as a powerful tool for aiding human creativity. While these tools can be helpful and enriching when used properly, in some cases, their use may be inappropriate. There are many situations where the use of LLM-generated text can be prevented, or at least be aware of its presence. For example, preserving originality in journalism and other online text content, maintaining the integrity of reviews for academic publications, or preventing cheating in educational settings. A human may be able to look for tell-tale signs of AI usage in a specific document, but often will be faced with large collections of many documents (e.g., all articles on a news website). Thus, the ability to not only detect AI-generated text in a large collection, but also estimate its extent/severity, is of great practical importance.

Previous solutions to this problem typically classify individual documents in the target corpus as AI or human generated, then aggregate these estimates to produce the final result. Such methods are known to suffer from unstable performance or to produce biased results, e.g., against documents written by non-native English speakers.

The present embodiments present an alternative method to address these issues and provide more accurate and stable estimates. The present embodiments detect AI-generated text for large document corpora by taking advantage of the maximum likelihood estimation of text distributions between AI-generated text document corpus and human-written document corpus with more accurate and stable estimates.

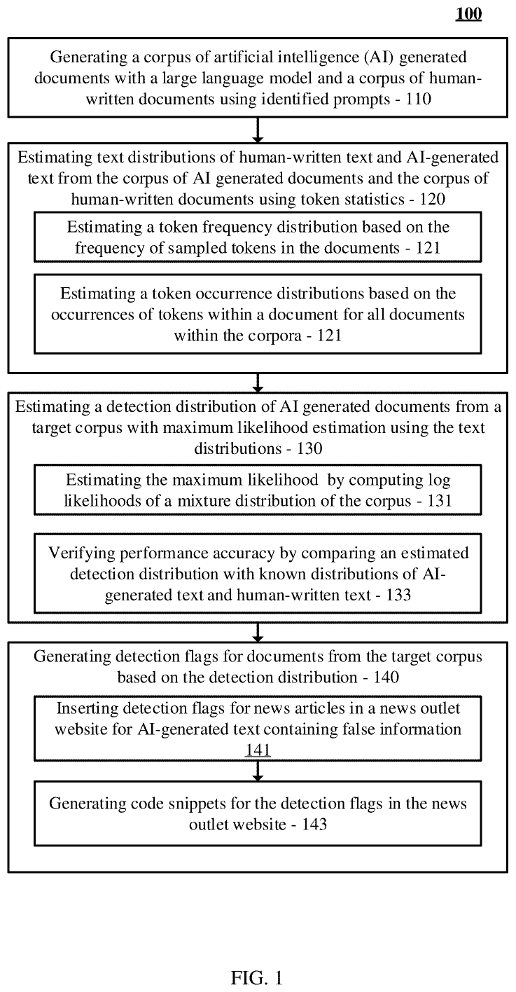

Referring now in detail to the figures in which like numerals represent the same or similar elements and initially to FIG. 1, a flow chart showing a high-level computer-implemented method for detecting artificial intelligence generated text in large document corpora, in accordance with one embodiment of the present invention.

In an embodiment, an AI-generated document corpus and a human-written document corpus can be generated using identified prompts. Text distributions of human-written text and AI-generated text from the corpus of AI generated documents and the corpus of human-written documents can be estimated using token statistics. A detection distribution of AI generated documents from a target corpus can be estimated with maximum likelihood estimation using the text distributions. Detection flags for the AI generated documents from the target corpus can be generated based on the detection distribution.

In block 110, an AI-generated document corpus and a human-written document corpus can be generated using identified prompts.

The human-written document corpus can include historical data which are (i) of the same type as the corpus to be classified (e.g., online news articles if the target corpus includes online news articles, academic reviews if the target corpus includes academic reviews, student essays if the target corpus includes student essays, etc.), and (ii) is known to contain only human generated text.

The identified prompts are the instructing text that the documents are based on. For example, for online news articles, this may be the article title or summary; for academic reviews, this may be the review questions and reviewed paper; for student essays, this may be the essay question.

In another embodiment, the identified prompts can be identified by generating a text describing the semantic similarity between the documents. For example, for articles written about how a rainbow is formed, the documents can be analyzed by a large language model (LLM) to generate the prompt “write an article about how a rainbow is formed.” The LLM can summarize each document and generate smaller text to identify the similarities between the summaries of each document and to identify the text describing the semantic similarity between the documents.

The AI-generated document corpus can include generated texts from the identified prompts using an LLM. To generate the AI generated corpus, the identified prompts from the human corpus can be fed into an LLM large language model (LLM) (e.g., ChatGPT™, pre-trained language model), and the LLM can be prompted to generate an article/review/essay/etc. The prompts can be fed into several different LLMs to generate training data which are more robust based on the AI generator used. The documents output by the LLM can be collected into the AI corpus.

In another embodiment, the human generated corpus can be compiled by a crawler that sifts through documents which are potentially human written and is verified based on the metadata of the document. For example, the meta data of a document for the creation date of the document can be verified to determine whether it was created before the start of the popularity of large language models. If it was before then, then it is likely human written.

In block 120, text distributions of human-written text and AI-generated text from the corpus of AI generated documents and the corpus of human-written documents can be estimated using token statistics.

The text distributions can represent the likelihood that the document within a corpus includes AI generated text or written by a human by using token statistics. The text statistics can include token frequency and token occurrence distributions.

In block 121, a token frequency distribution can be estimated based on the frequency of sampled tokens in the documents. It can be assumed that documents are generated by repeatedly sampling tokens from a token frequency distribution. The sampling continues until a “stop” token is sampled, at which point the document is completed and no more tokens are sampled. In this case, P and Q follow a generalized geometric distribution. A consistent estimate for the probability that token t is sampled at each step in this process is given by \hat{p}(t) as the number of occurrences of token t in the human corpus over the total number tokens in the human corpus. The same procedure can be used to estimate \hat{q}(t), the token probability for the AI distribution Q. Let xᵢⱼ be the j-th token in document xᵢ, and let |xᵢ| denote the length (total number of tokens, including the “stop” token) in xᵢ. The estimated probability of xᵢ under P, the human generated document distribution, and Q, the AI generated document distribution, is then given by P(xᵢ)=Πᵢ₌₁^{|x}^{ᵢ}^{|}\hat{p}(xᵢⱼ), and Q(xᵢ)=Πᵢ₌₁^{|x}^{ᵢ}^{|}\hat{q}(xᵢⱼ), respectively.

In block 123, the token occurrence distributions can be estimated based on the occurrences of tokens within a document for all documents within the corpora. Each document x can be represented as a list of occurrences (e.g., a set) of tokens rather than a list of token counts. While longer documents will tend to have more unique tokens (and thus a lower likelihood in this model), the number of additional unique tokens is likely sublinear in the document length, leading to a less exaggerated down-weighting of longer documents.

The occurrence probabilities for the human document distribution can be estimated by \hat{p}(t) which is the likelihood of the number of documents in which token t appears over the total number of documents in the corpus or via

$$\hat{p} ( t ) = \frac{\sum x ∈ X 1 \{ t ∈ x \}}{\vert X \vert} ,$$

where X is the corpus of human-written documents. Similarly, the occurrence probabilities for the AI generated document distribution can be estimated by \hat{q}(t) can be defined as

$$\hat{q} ( t ) = \frac{\sum x ∈ Y 1 \{ t ∈ x \}}{\vert Y \vert} ,$$

where Y is the corpus of AI generated documents.

Using the notation t Ex to denote that token t occurs in document x, P, the human generated document distribution, can then be estimated via P(xᵢ)=Π_{t∈x}\hat{p}(t)×Π_{t∉x}(1−\hat{p}(t)). Similarly, Q, the AI generated document distribution, can then be estimated via Q(xᵢ)=Π_{t∈x}\hat{q}(t)×Π_{t∉x}(1−\hat{q}(t)).

In another embodiment, the token frequency and token occurrence can be employed in a combined manner and the estimation procedure that resulted in the higher estimated distribution of AI-generated text can be employed.

In block 130, a detection distribution of AI generated documents from a target corpus can be estimated with maximum likelihood estimation using the text distributions.

Once P and Q are estimated, the detection distribution a of AI generated documents from a target corpus can be estimated via maximum likelihood estimation (MLE). MLE estimates the parameters of an assumed probability given some observed data by maximizing a likelihood function so that the observed data has the maximum probability based on the assumed probability distribution.

In block 131, the maximum likelihood can be estimated by computing the log likelihood of the mixture distribution of the corpus. Given a collection of n documents {xᵢ} n i=1 drawn independently from the mixture (1), the log-likelihood (L) of the corpus is given by L(α)=Σᵢ₌₁ⁿ log ((1−α)P(xᵢ)+αQ(xᵢ)).

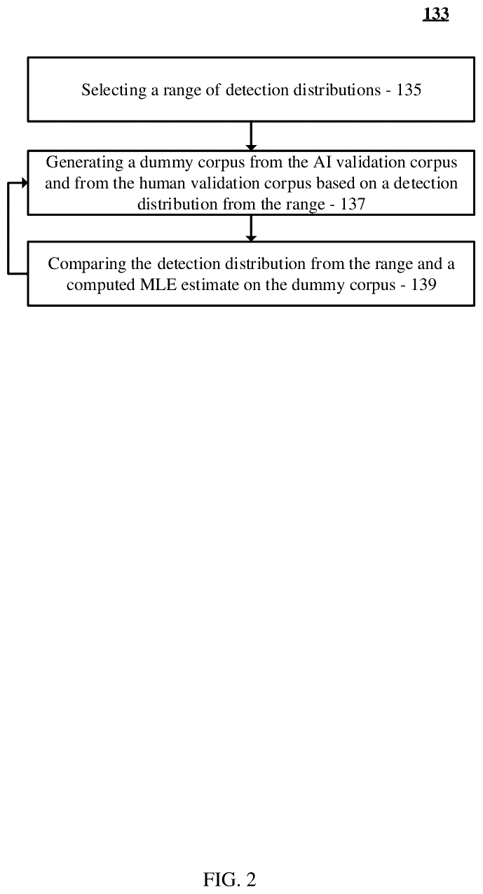

In block 133, the performance accuracy can be verified by comparing an estimated detection distribution with known distributions of AI-generated text and human-written text. This is shown in more detail in FIG. 2.

Referring now to FIG. 2, a flow diagram showing verifying performance accuracy by comparing an estimated detection distribution with known distributions of AI-generated text and human-written text, in accordance with an embodiment of the present invention.

The human and AI corpora can be partitioned into two disjoint parts. For example, 80% of the human corpora and the AI corpora can be used for training; while 20% of the human corpora and the AI corpora can be used for validation. The training partitions of the human and AI corpora will be used to estimate P and Q as described herein. To validate the system's performance, the following can be performed:

In block 135, a range of detection distributions can be selected. The range can include an element of numbers from 0 to 1.

For example, the range of feasible values for a can include a α∈ {0, 0.05, 0.1, 0.15, 0.2, 0.25}.

In block 137, a dummy corpus from the AI validation corpus and from the human validation corpus based on a detection distribution from the range can be generated.

Let n be the size of the target corpus. For each of the selected a values, sample (with replacement) a n documents from the AI validation corpus and (1-a) n documents from the human validation corpus to create a dummy target corpus.

In block 139, the detection distribution from the range and a computed MLE estimate on the dummy corpus can be compared.

Compute the MLE estimate \hat{α} on the dummy target corpus. If \hat{α}≈α for each of the feasible α values, this provides evidence that the system is working correctly and the estimate can be trusted.

Blocks 137-139 can be repeated multiple times to generate confidence intervals for the estimate \hat{α} until the detection distributions within the selected range are processed. In an embodiment, a flag generator can verify the performance accuracy.

In block 140, detection flags for documents from the target corpus can be generated based on the detection distribution.

The detection flags can include a text that signifies that the document includes AI-generated text. The detection flags can include the detected AI-generated text that is highlighted (e.g., highlighted, displayed in different font color, underlined, etc.). The detection flags can be generated as another page in the document which details the summary of the analysis which can include the excerpts of the AI-generated text, the detection distribution of AI generated documents in relation to the corpus, etc. In another embodiment, the detection flags can be generated as a code snippet that can be inserted into a website. In another embodiment, the detection flags can be generated as meta information that describes the detection distribution of AI generated documents from the target corpus.

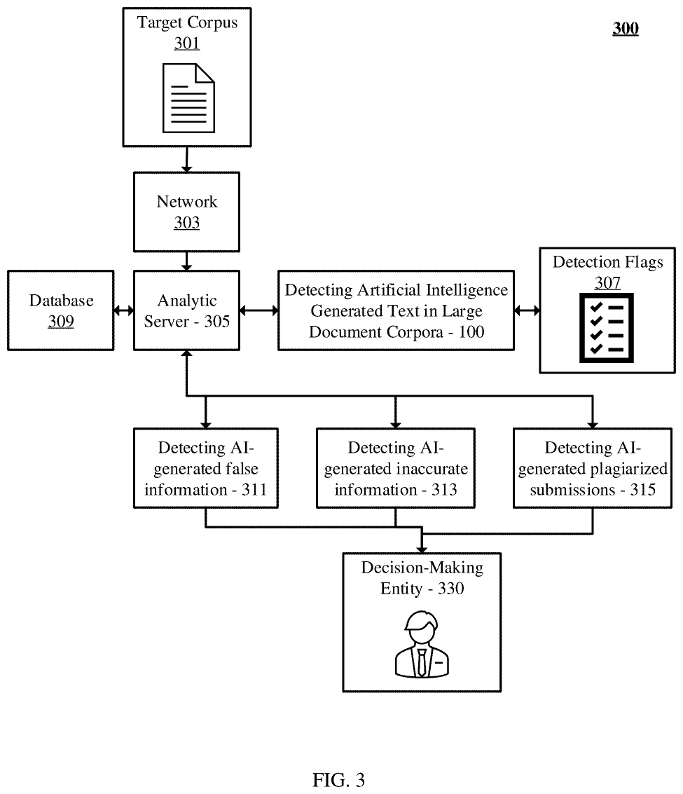

This is shown in more detail in FIG. 3.

Referring now to FIG. 3, a block diagram showing a system implementing practical applications for detecting AI-generated text in large document corpora, in accordance to an embodiment of the present invention.

A decision-making entity 330 can instruct the system 300 to analyze a target corpus 301 and detect AI-generated text within. The target corpus 301 can then be transmitted to a network 303 that communicates with an analytic server 305. The analytic server 305 can perform detecting artificial intelligence generated texts in large document corpora 100 which can generate detection flags 307 for the target corpus. The analytic server 305 can perform detecting AI-generated false information 311, detecting AI-generated inaccurate information 313, detecting AI-generated plagiarized submissions 315 which can assist the decision-making process of the decision-making entity 330.

For detecting AI-generated false information 311, the database 309 can verify whether the entire information generated by AI is incorrect or false. The detection flags 307 can be generated for the entire AI-generated text and an appropriate message can be included to notify the decision-making entity 330 that the AI-generated text is false. For example, in block 141 of FIG. 1, articles in a news website can include detection flags 307 that can be inserted if the entire news article contains AI-generated text and the content of the news article is false. In the same example, in block 143 of FIG. 1, the detection flags 307 can be generated as a code snippet that can be inserted into the section of website for the news outlet that published the news article. The detection flags 307 can include the detection distribution that describes the number of news articles that contains the false information generated by AI compared to the entirety of the news outlet site.

For detecting AI-generated inaccurate information 313, the database 309 can verify whether portions of the information generated by AI is incorrect or false. The detection flags 307 can be generated for the portions of AI-generated text and an appropriate message can be included to notify the decision-making entity 330 that the AI-generated text is false or inaccurate.

For detecting AI-generated plagiarized submissions 315, the database 309 can verify whether portions or the entire text generated by AI from the submission is plagiarized. The detection flags 307 can be generated for the portions of AI-generated text and an appropriate message can be included to notify the decision-making entity 330 that the AI-generated text is plagiarized.

Other practical applications are contemplated.

Thus, the present embodiments can detect AI-generated text from large document corpora by taking advantage of the maximum likelihood estimation of text distributions between AI-generated text document corpus and human-written document corpus with more accurate and stable estimates.

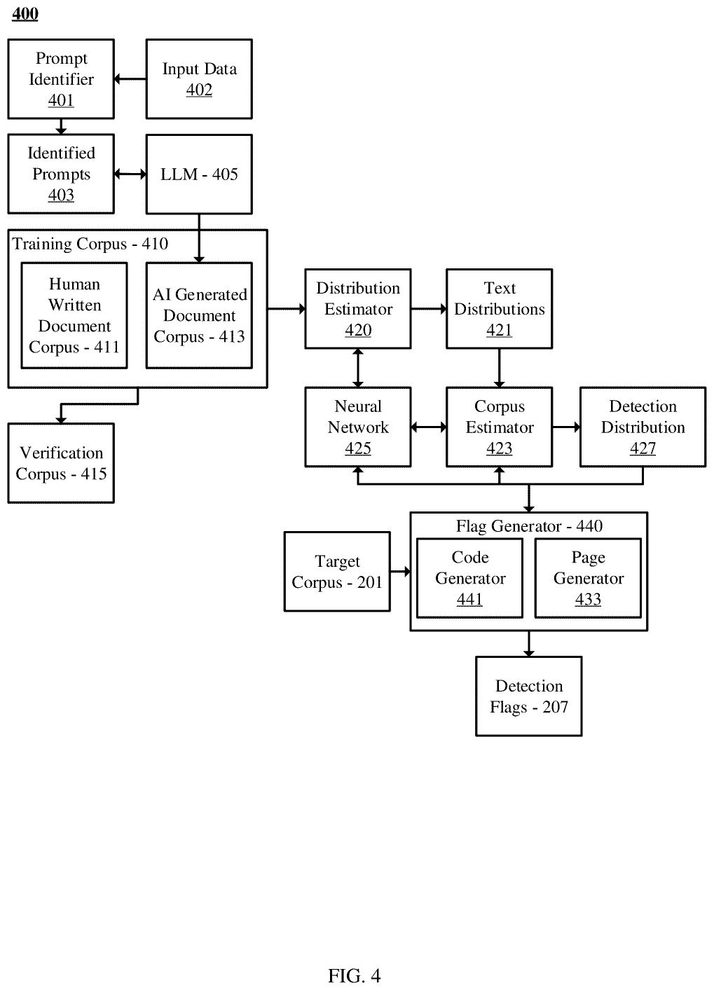

Referring now to FIG. 4, a block diagram showing a system for detecting artificial intelligence generated text in large document corpora, in accordance with an embodiment of the present invention.

In system 400, a prompt identifier 401 can identify identified prompts 403 based on input data 402. The prompt identifier 401 can utilize LLM 405 to identify identified prompts. The LLM 405 can generate an AI generated document corpus 413 based on the identified prompts 403. The input data 402 can include the human written document corpus 411.

The training corpus 410 can include the human written document corpus 411 and the AI generated document corpus 413. In another embodiment, a verification corpus 415 can be generated from the training corpus 410. The training corpus 410 can be used to train a distribution estimator 420 to estimate text distributions 421.

The distribution estimator 420 can utilize a neural network 425 which is trained using the training corpus 410. The text distributions 421 can be used to train a corpus estimator 423 to estimate the detection distribution 427. The corpus estimator 423 can also utilize the neural network 425.

The flag generator 440 can generate detection flags 307 from a target corpus 301 based on the text distributions 421 and the detection distribution 427. The flag generator 440 can utilize neural network 425. The flag generator 440 can include a code generator 441 which can generate code snippets which can be inserted into webpages and a page generator 433 which can insert pages into documents. The flag generator 440 can also generate meta information for the target corpus 301 that can include the detection flags 307.

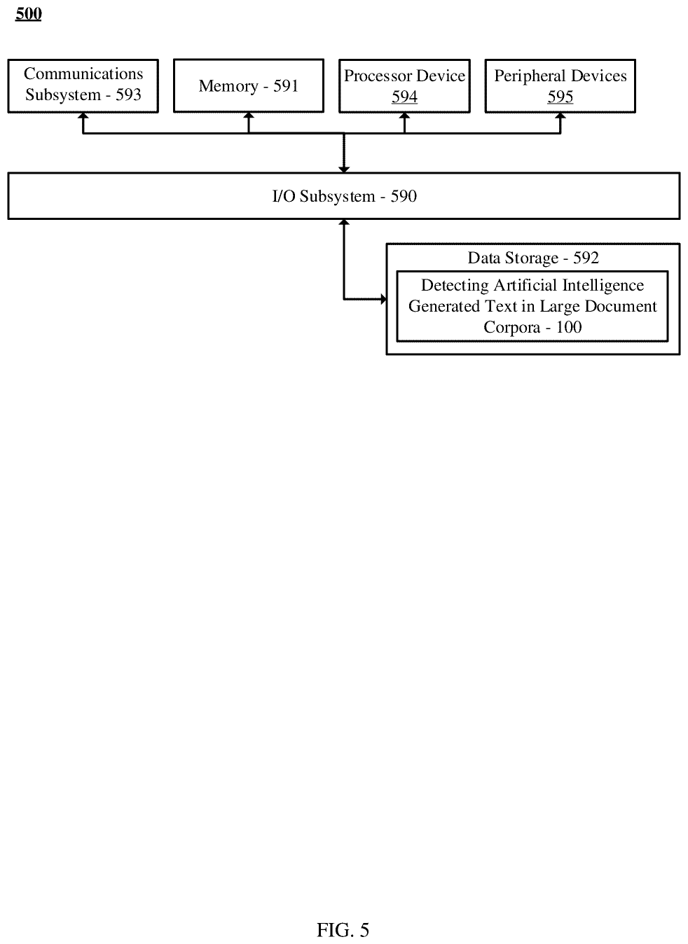

Referring now to FIG. 5, a block diagram showing a system for detecting artificial intelligence generated text in large document corpora, in accordance with an embodiment of the present invention.

The computing device 500 illustratively includes the processor device 594, an input/output (I/O) subsystem 590, a memory 591, a data storage device 592, and a communication subsystem 593, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 591, or portions thereof, may be incorporated in the processor device 594 in some embodiments.

The processor device 594 may be embodied as any type of processor capable of performing the functions described herein. The processor device 594 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 591 may be embodied as any type of volatile or non-volatile memory or data storage capable of performing the functions described herein. In operation, the memory 591 may store various data and software employed during operation of the computing device 500, such as operating systems, applications, programs, libraries, and drivers. The memory 591 is communicatively coupled to the processor device 594 via the I/O subsystem 590, which may be embodied as circuitry and/or components to facilitate input/output operations with the processor device 594, the memory 591, and other components of the computing device 500. For example, the I/O subsystem 590 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 590 may form a portion of a system-on-a-chip (SOC) and be incorporated, along with the processor device 594, the memory 591, and other components of the computing device 500, on a single integrated circuit chip.

The data storage device 592 may be embodied as any type of device or devices configured for short-term or long-term storage of data such as, for example, memory devices and circuits, memory cards, hard disk drives, solid state drives, or other data storage devices. The data storage device 592 can store program code for detecting artificial intelligence generated text in large document corpora 100. Any or all of these program code blocks may be included in a given computing system.

The communication subsystem 593 of the computing device 500 may be embodied as any network interface controller or other communication circuit, device, or collection thereof, capable of enabling communications between the computing device 500 and other remote devices over a network. The communication subsystem 593 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 592. The peripheral devices 592 may include any number of additional input/output devices, interface devices, and/or other peripheral devices. For example, in some embodiments, the peripheral devices 592 may include a display, touch screen, graphics circuitry, keyboard, mouse, speaker system, microphone, network interface, and/or other input/output devices, interface devices, GPS, camera, and/or other peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 500 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

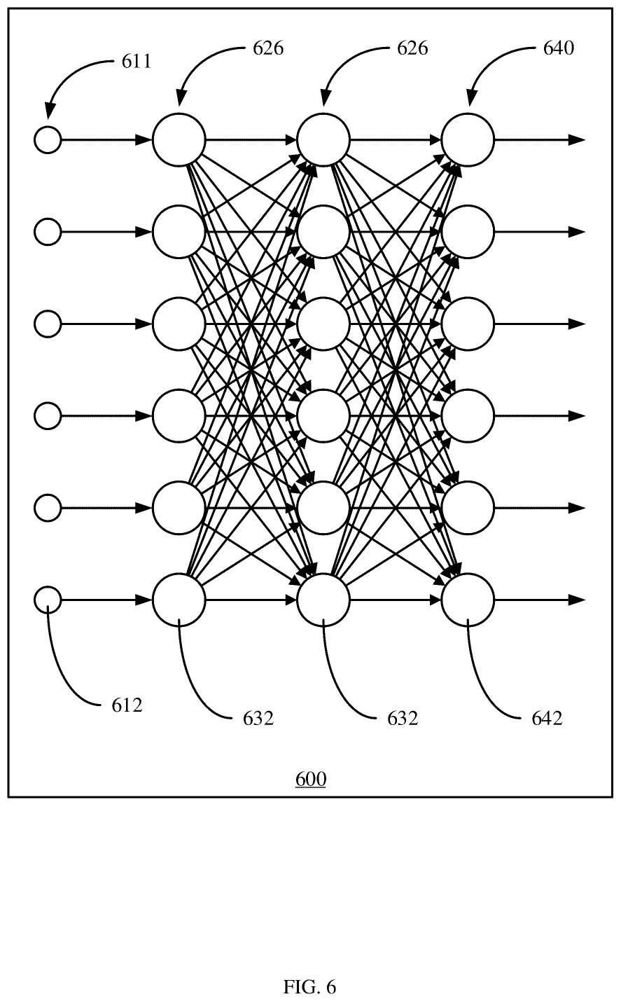

Referring now to FIG. 6, a block diagram showing a structure of deep neural networks for detecting artificial intelligence generated text in large document corpora, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 600, such as a multilayer perceptron, can have an input layer 611 of source neurons 612, one or more computation layer(s) 626 having one or more computation neurons 632, and an output layer 640, where there is a single output neuron 642 for each possible category into which the input example could be classified. An input layer 611 can have a number of source neurons 612 equal to the number of data values 612 in the input data 611. The computation neurons 632 in the computation layer(s) 626 can also be referred to as hidden layers, because they are between the source neurons 612 and output neuron(s) 642 and are not directly observed. Each neuron 632, 642 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, W₂, . . . . Wₙ₋₁, Wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 626 of the neural network 425 can learn the semantic relationships between the training corpus 410 and the text distributions 421. The output layer 640 of the neural network 425 can then provide the overall response of the network as the detection distribution 427 based on the training corpus 410. In another embodiment, the neural network 425 can learn the detection distribution 427 from target corpus 301 based on past text distributions 421 and detection distributions 427.

Training a deep neural network can involve two phases, a forward phase where the weights of each neuron are fixed and the input propagates through the network, and a backwards phase where an error value is propagated backwards through the network and weight values are updated. The computation neurons 632 in the one or more computation (hidden) layer(s) 626 perform a nonlinear transformation on the input data 612 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for detecting artificial intelligence (AI) generated text, comprising:
generating a corpus of artificial intelligence (AI) generated documents with a large language model and a corpus of human-written documents using identified prompts;
estimating text distributions of human-written text and AI-generated text from the corpus of AI generated documents and the corpus of human-written documents using token statistics;
estimating a detection distribution of AI generated documents from a target corpus with maximum likelihood estimation using the text distributions; and
generating detection flags for the AI generated documents from the target corpus based on the detection distribution.

2. The computer-implemented method of claim 1, wherein generating the detection flags further comprises inserting detection flags for news articles in a news outlet website for AI-generated text containing false information.

3. The computer-implemented method of claim 2, wherein generating the detection flags further comprises generating code snippets for the detection flags in the news outlet website.

4. The computer-implemented method of claim 1, wherein estimating the detection distribution further comprises estimating the maximum likelihood by computing log likelihoods of a mixture distribution of a corpus.

5. The computer-implemented method of claim 1, wherein estimating the detection distribution further comprises verifying performance accuracy by comparing an estimated detection distribution with known distributions of AI-generated text and human-written text.

6. The computer-implemented method of claim 1, wherein estimating the text distributions further comprises estimating token occurrence based on the occurrences of tokens within a document for all documents within a corpus.

7. The computer-implemented method of claim 1, wherein estimating the text distributions further comprises estimating a token frequency distribution based on the frequency of sampled tokens in the documents.

8. A system for detecting artificial intelligence (AI) generated text, comprising:
a memory device;
one or more processor devices operatively coupled with the memory device causing the processor devices to perform:
generating a corpus of artificial intelligence (AI) generated documents with a large language model and a corpus of human-written documents using identified prompts;
estimating text distributions of human-written text and AI-generated text from the corpus of AI generated documents and the corpus of human-written documents using token statistics;
estimating a detection distribution of AI generated documents from a target corpus with maximum likelihood estimation using the text distributions; and
generating detection flags for documents from the target corpus based on the detection distribution.

9. The system of claim 8, wherein generating detection flags further comprises inserting detection flags for news articles in a news outlet website for AI-generated text containing false information.

10. The system of claim 9, wherein generating detection flags further comprises generating code snippets for the detection flags in the news outlet website.

11. The system of claim 8, wherein estimating the detection distribution further comprises estimating the maximum likelihood by computing log likelihoods of a mixture distribution of a corpus.

12. The system of claim 8, wherein estimating the detection distribution further comprises verifying performance accuracy by comparing an estimated detection distribution with known distributions of AI-generated text and human-written text.

13. The system of claim 8, wherein estimating the text distributions further comprises estimating token occurrence based on the occurrences of tokens within a document for all documents within a corpus.

14. The system of claim 8, wherein estimating the text distributions further comprises estimating a token frequency distribution based on the frequency of sampled tokens in the documents.

15. A non-transitory computer program product comprising a computer-readable storage medium including program code for detecting artificial intelligence (AI) generated text, wherein the program code when executed on a computer causes the computer to perform:
generating a corpus of artificial intelligence (AI) generated documents with a large language model and a corpus of human-written documents using identified prompts;
estimating text distributions of human-written text and AI-generated text from the corpus of AI generated documents and the corpus of human-written documents using token statistics;
estimating a detection distribution of AI generated documents from a target corpus with maximum likelihood estimation using the text distributions; and
generating detection flags for documents from the target corpus based on the detection distribution.

16. The non-transitory computer program product of claim 15, wherein generating detection flags further comprises inserting detection flags for news articles in a news outlet website for AI-generated text containing false information.

17. The non-transitory computer program product of claim 15, wherein estimating the detection distribution further comprises estimating the maximum likelihood by computing log likelihoods of a mixture distribution of the corpus.

18. The non-transitory computer program product of claim 15, wherein estimating the detection distribution further comprises verifying performance accuracy by comparing an estimated detection distribution with known distributions of AI-generated text and human-written text.

19. The non-transitory computer program product of claim 15, wherein estimating the text distributions further comprises estimating token occurrence based on the occurrences of tokens within a document for all documents within a corpus.

20. The non-transitory computer program product of claim 15, wherein estimating the text distributions further comprises estimating a token frequency distribution based on the frequency of sampled tokens in the documents.
